(19) United States
(12) Patent Application Publication
(10) Pub. No.: US 2013/0031886 A1
(43) Pub. Date: Feb. 7, 2013

(54) Snapstick

(71) Applicants: Andrea Mock, Austin, TX (US); James Mock, Austin, TX (US)

(72) Inventors: Andrea Mock, Austin, TX (US); James Mock, Austin, TX (US)

(21) Appl. No.: 13/137,298

(22) Filed: Aug. 3, 2011

(51) Int. Cl. B01D 46/42

(52) U.S. Cl. 55/502

(57) ABSTRACT

SNAPSTIK's unique gripping features eliminates air bypass between air filters when connected properly. The gripping feature was developed by examining numerous poly vinyl chloride (PVC) resins to establish the final formulation. The vinyl formulation allows for the PVC to retain its memory to return to its original position. After hundreds of tests, the material's gripping feature showed minimal degradation of the material. SNAPSTIK, when installed properly, connects and holds with its unique gripping features each air filter within the air handling duct tracks, allowing for elimination of air bypass.

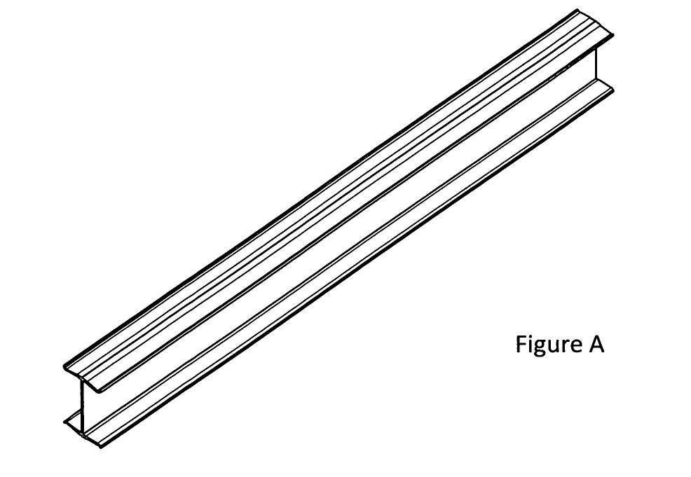

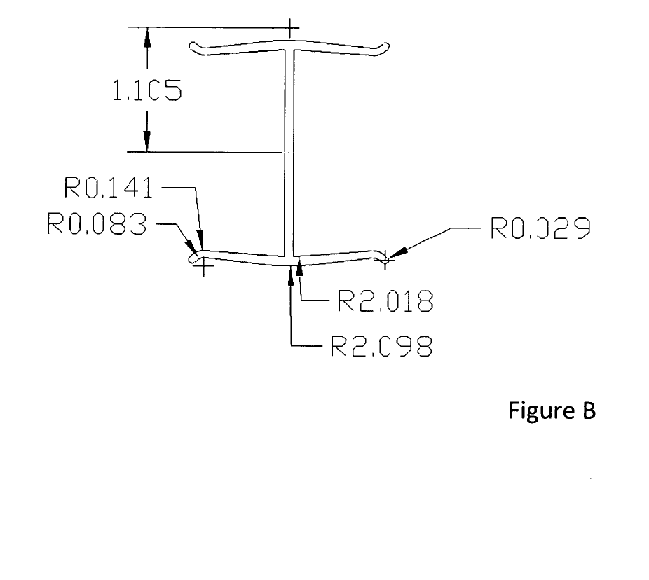

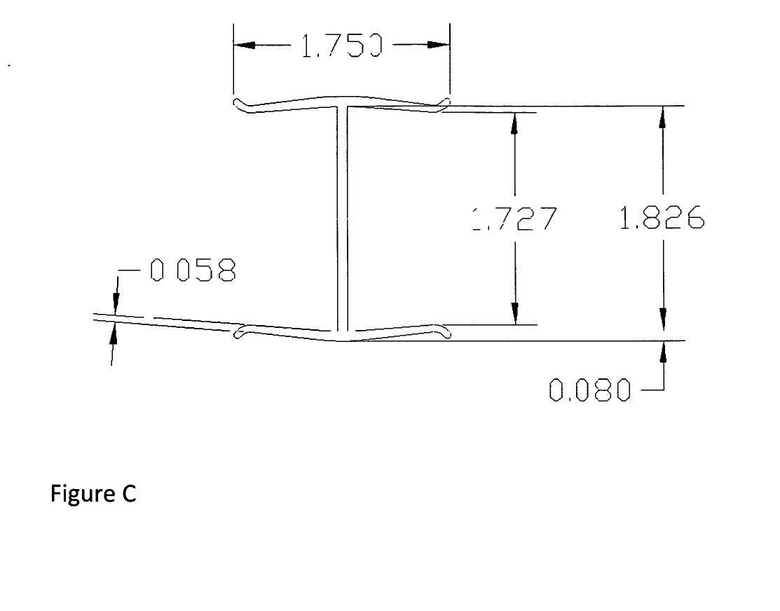

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Heating, Ventilation, and Air Conditioning (HVAC) air filtration systems air bypass solution. SNAPSTIK is a strip that eliminates air bypass when installed with correct HVAC filter sizes.

### BRIEF SUMMARY OF INVENTION

Currently, improper filter installation can create gaps around and in between the filters in HVAC systems, allowing air to bypass the filter.

SNAPSTIK eliminates air bypass that will cause HVAC coils and fans to become dirty which can increase operating costs through inefficient operation and increased maintenance.

Even moderate amounts of filter bypass can dramatically increase HVAC heat exchanger fouling. Dirty heat exchangers have diminished heat transfer performance and increased pressure drop, leading to significantly increased energy use and decreased heating and cooling performance.

### BRIEF DESCRIPTION OF THE SEVERAL VIEWS OF THE DRAWING

FIG. A—Isometric View of Extrusion

FIG. B—Arcs Dimensioned of Profile

FIG. C—Horizontal and Vertical Dimensions of Profile

### DETAILED DESCRIPTION OF THE INVENTION

The manufacturing steps required to make SNAPSTIK are the following: First, extrusion dies are made to specifications of engineering drawings, which are contained in this patent application; Second, dies are inserted into industrial extrusion machine; Third, a polyvinyl chloride composite material is mixed to specification; Fourth, polyvinyl chloride composite is extruded through dies; Fifth, extruded sections are twelve feet in length, allowed to cool and packaged.

1. SNAPSTIK's unique gripping features eliminates air bypass between air filters when connected properly.

2. SNAPSTIK, when installed properly, connects with it's unique gripping features each air filter within the air handling duct tracks, allowing for easy insertion or removal of air filters.
